(19) United States
(12) Patent Application Publication
(10) Pub. No.: US 2007/0165875 A1
(43) Pub. Date: Jul. 19, 2007

(54) High fidelity multimedia wireless headset

(76) Inventors: Behrooz Rezvani, San Ramon, CA (US); Andrea Goldsmith, Menlo Park, CA (US)

Correspondence Address: PERKINS COIE LLP, P.O. BOX 2168, MENLO PARK, CA, 94026, US

(21) Appl. No.: 11/607,431

(22) Filed: Dec. 1, 2006

Related U.S. Application Data
(60) Provisional application No. 60/741,672, filed on Dec. 1, 2005.

(51) Int. Cl. H04R 1/10

(52) U.S. Cl. 381/74; 381/367

(57) ABSTRACT

The invention provides a multiple-antenna wireless multimedia headset with high fidelity sound, peer-to-peer networking capability, seamless handoff between multiple wireless interfaces, multimedia storage with advanced search capability, and ultra low power such that the device is capable of operation without recharging. The headset supports multiple wireless systems such as Wifi (802.11a/b/g/n), Wimax, 3G cellular, 2G cellular, GSM-EDGE, radio (e.g. AM/FM/XM), 802.15 (Bluetooth, UWB, and Zigbee) and GPS. The headset also provides a platform such that applications can access the high fidelity sound system, the speech recognition engine, the microprocessor, and the wireless systems on the device.

### BACKGROUND

1. Field of the Invention

The present invention generally relates to wireless multimedia headsets.

2. Description of the State-of-the-Art

Wireless headsets are common devices used for hands-free operation in conjunction with cell phones and VoIP phones, as well as with portable music players such as digital MP3 players. Such headsets typically include radio technology to access a given wireless system. For example, cell phone headsets use wireless technology to communication with the cell phone handset such that the voice signals received by the handset over the cell phone system can be transferred to the headset. Similarly, wireless headsets for MP3 players use wireless technology to transfer music files from the player to the headset.

### BRIEF DESCRIPTION OF THE DRAWINGS

FIG. 1 provides a functional block diagram showing the features of the headset according to some embodiments.

FIG. 2 illustrates the subsystems that support the various functionalities according to some embodiments.

FIG. 3 illustrates a model for the user interface via speech recognition according to some embodiments.

FIG. 4 illustrates a microphone array for a high fidelity sound system according to some embodiments.

FIG. 5 illustrates an exemplary situation in which a human speaker (user) is making sounds or an utterance toward an array of microphones including a plurality of individual microphones or microphone sets according to some embodiments.

FIG. 6 illustrates a flowchart of the multistep process by which a user locates a desired music file or set of files (or other type of multimedia file) according to some embodiments.

FIG. 7 illustrates details of the power management algorithm according to some embodiments.

FIG. 8 illustrates simultaneous operation over a cellular system and a Wifi system according to some embodiments.

FIG. 9 illustrates a peer-to-peer networking protocol used to establish direct or multihop connections with other wireless devices for real-time interaction and file exchange according to some embodiments.

FIG. 10 illustrates a flow chart describing this process according to some embodiments.

### SUMMARY

In one aspect the invention provides a High-Fidelity Multimedia Wireless Headset. In another aspect, the invention provides a wireless multimedia headset that can include multiple features such as multimedia storage with advanced search capability, a high fidelity sound system, peer-to-peer networking capability, and ultra low power such that the device is capable of operation without recharging.

In another aspect, the invention provides a multimedia headset and method for designing and operating a headset comprising: a plurality of multiple wireless interfaces; an advanced search engine with media search capability; a high fidelity sound processor; power management means for ultra low power operation; and network connectivity for peer-to-peer networking.

### DETAILED DESCRIPTION

The present disclosure is generally directed to a wireless multimedia headset that can include multiple features and support multiple wireless systems. These features can include any combination of a multimedia storage with advanced search capability; a high fidelity sound system; peer-to-peer networking capability; and an ultra low power consumption, such that the device is capable of operation without recharging. The headset can also provide a platform for both existing and new headset applications (such as “push-to-talk” between headsets) to enable access to the device features.

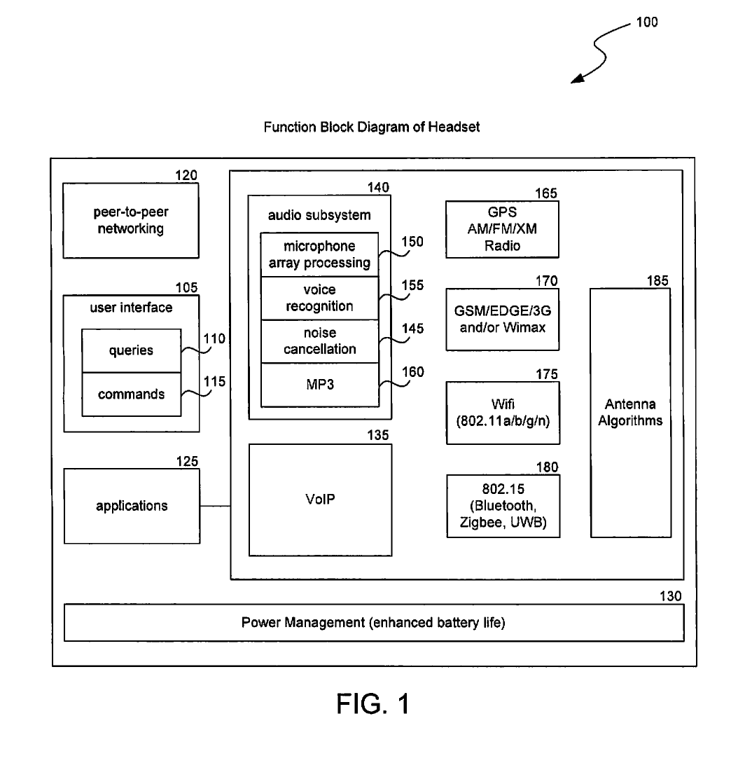

FIG. 1 provides a functional block diagram showing the features of the headset according to some embodiments. In these embodiments, the headset 100 comprises a user interface 105 having query 110 and command 115 functionality for voice recognition. The headset 100 includes a peer-to-peer networking 120 functionality that will allow any headset within range of other wireless devices to self-configure with them into a multihop network.

The headset 100 is capable of several applications 125, in addition to power management 130 to enhance battery life. The headset 100 supports Voice over IP (VoIP) 135 directly through any of the interfaces that allow it to connect to the Internet, as well as an audio subsystem 140 that includes several functionalities such as, for example, noise cancellation 145 (and beamforming) through microphone array processing 150, in addition to voice recognition 155 and MP3 support 160. Multiple wireless systems may be integrated into the headset 100, including, but not limited to, GPS and different radio systems (AM/FM/XM) 165, various cellular phone standards (3G/2G/GSM/Edge and/or Wimax) 170, different Wifi standards (802.11a/b/g/n) 175, and 802.15 (Bluetooth, Zigbee, and/or UWB) 180. In most embodiments, an antenna, or array of antennas, having antenna algorithms 185 is used as part of the wireless system or subsystems disclosed herein.

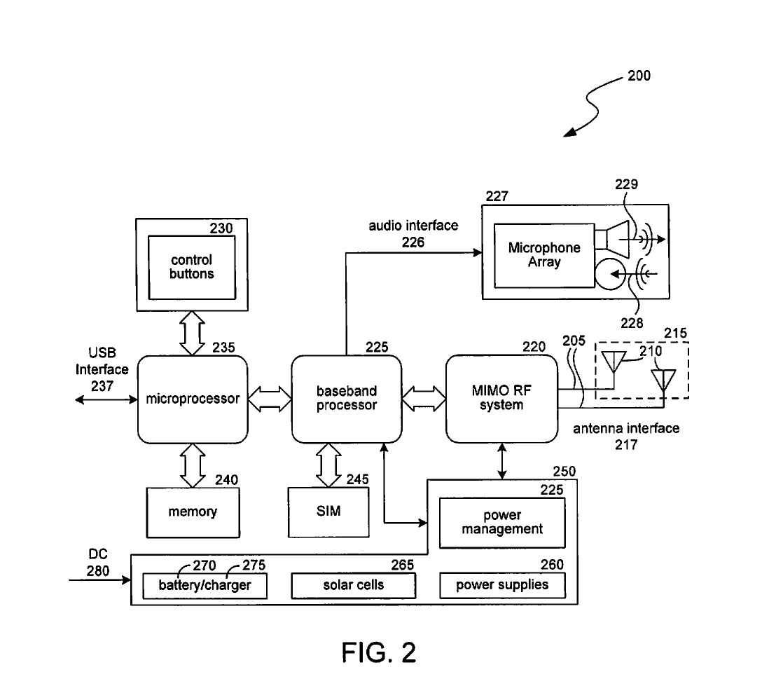

FIG. 2 illustrates the subsystems that support the various functionalities according to some embodiments. In these embodiments, the signals 205 received from the antenna 210, or array of antennas 215, through antenna interface 217 are processed by a MIMO RF system 220 and a baseband processor 225. The subsystems include an audio interface 227 having a microphone array 227 having an input 228 and an output 229. The subsystems include control buttons 230 for the user interface 105 as well as voice recognition 155. And, a microprocessor 235 having a USB interface 237 is present to perform the arithmetic, logic, and control operations for the various functionalities through the assistance of an internal memory 240.

The device also includes a SIM card 245 that, for example, identifies the user account with a network, handles authentication, provides data storage for basic user data and network information, and may also contain applications. The powers subsystems 250 include advanced power management 255 functionality to control energy use through power supplies 260. Solar cells 265 are also available to assist in sustaining the supply of power. The solar cells 265 can charge the battery 270 from ambient light as well as solar light. A battery charger 275 is included and can charge the battery, for example, through the input of a DC current 280.

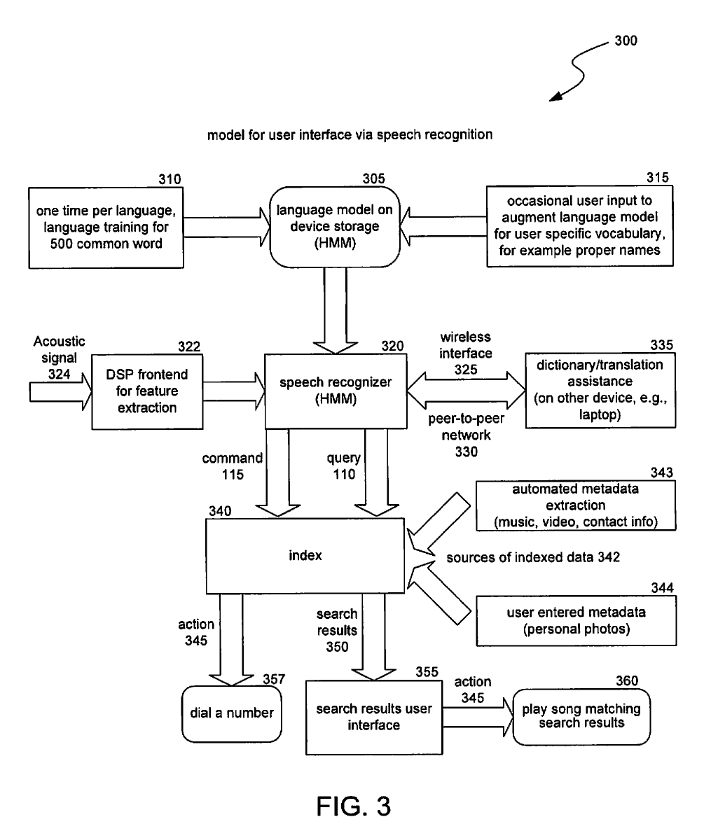

FIG. 3 illustrates a model for the user interface via speech recognition according to some embodiments. In these embodiments, there is a set language models stored on the device called Hidden Markov Models (HMMs) 305 for the speech data, and these models may be enhanced through some amount of initial user training 310. In addition, occasional user input 315 either as commands, or through users speaking for a voice application, can be used to augment the HMMs 305. The HMMs 305 are included in the speech recognizer 320 within in a speech recognition algorithm.

The speech recognizer 320 receives information from a digital signal processor (DSP) 322, which collects, processes, compresses, transmits and displays analog and digital data for feature extraction from an acoustic signal 324. The speech recognizer 320 is designed such that the wireless interfaces 325 and/or peer-to-peer network 330 can be used to provide an additional input to the algorithm. Specifically, the algorithm will have the ability to use any of the available wireless interfaces 325 and/or peer-to-peer network 330 to connect to another device 335 such as, for example, a laptop, computer, or handset to include other capabilities including, but not limited to, expanding the vocabulary base or providing translation assistance to the engine in the speech recognizer 320.

The algorithm will take the user's speech as a query 110 or command 115 input and initiate an indexing function 340. The sources of indexed data 342 include, but are not limited to, automated metadata extraction 343 and user entered metadata 344. Automated metadata 343 includes, for example, music, video, and contact information. User entered metadata 344 includes, for example, personal photographs. For commands, the indexing function 340 will take the appropriate action 345 to satisfy the command 115. For queries, 110 the indexing function 340 will enable the search engine to locate the desired file and provide search results 350 to the user interface 355 and then take the appropriate action 345, such as dialing a number 357 or playing a desired song 360.

The algorithms for noise cancellation (and beamforming) 145 based on the microphone array input 228 speech can be designed relative to the speech recognition algorithm, such that the feature extraction of the input 228 speech is optimized. One of skill will appreciate that noise cancellation/beamforming algorithms designed independent of the speech recognition algorithms can degrade speech recognition performance by introducing undesired speech artifacts. The speech recognition will categorize recognized speech as either a query 100 (e.g. look for a particular song) or a command 115 (e.g. dial a specific number).

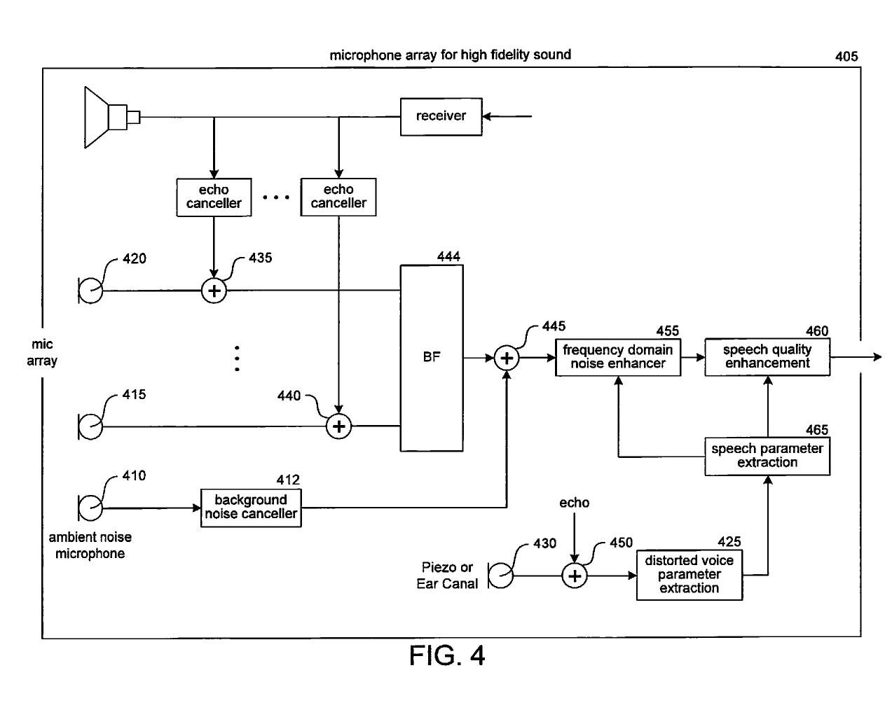

FIG. 4 illustrates a microphone array for a high fidelity sound system according to some embodiments. The microphone array 405 is coupled with a noise cancellation algorithm to pick up sound. The microphone array 405 includes an ambient noise microphone 410 located on a part of the headset optimized to pick up background ambient noise and cancel it through a background noise canceller 412, as well as additional microphone elements 415,420,430 in different locations on the headset. The plurality of acoustic microphone signals are transduced into corresponding electrical microphone output signals by the microphones and communicated to the beam forming block 444.

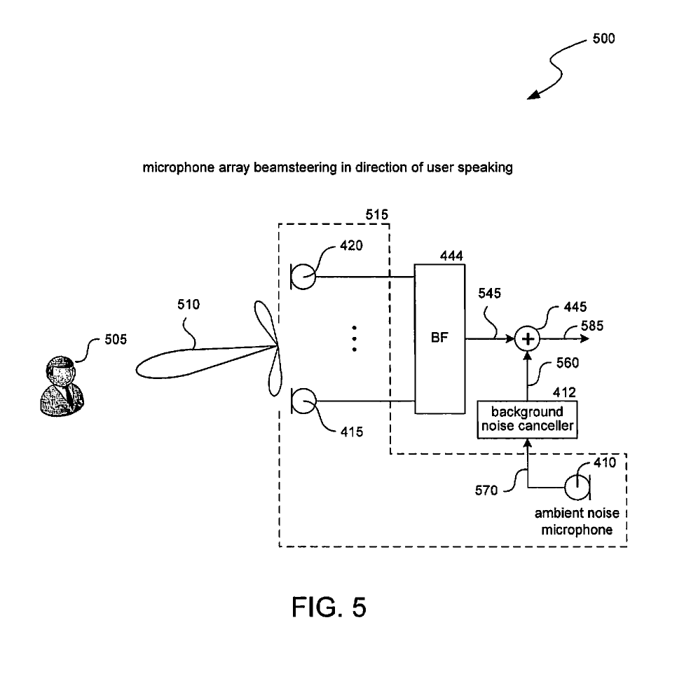

An additional antenna element may be placed inside the ear canal with signal processing through a distorted voice parameter extraction component 425 to invert the distortion of the ear canal transmission and enhance the voice parameters. The antenna elements 435,440,445,450 in the microphone array will have weights assigned to each antenna input. Different algorithms can be used to determine the weights, depending on the performance criteria, the number of antenna elements available and their nature, and the algorithm complexity. For example, the weights may be used to minimize ambient noise, to make the antenna array gain independent of frequency, to minimize the expected mean square distortion or error of the signal, or to steer the direction of the microphone array 227 towards the speaker as shown in FIG. 5. Other functions of the microphone array include a frequency domain noise enhancer 455, a speech quality enhancer 460, and speech parameter extraction 465.

FIG. 5 illustrate an exemplary situation in which a human speaker (user) is making sounds or an utterance toward an array of microphones including a plurality of individual microphones or microphone sets according to some embodiments. The plurality of microphones 410,415,420 in the array 515 receive a somewhat different acoustic signal from the human speaker (or user) 505 due to their different relative positions or distances from the human speaker (or user) 505. The different acoustical signals may be due for example to a different distance or angle of incidence of the acoustic wave generated by the human speakers utterance, and it may also include or be affected by reflective and/or reflective surfaces in the room or other environment in which the speech, sound, or utterance 510 picked up by the microphone array 515 takes place. The time of arrival of the signal may also differ and be used alone or in conjunction with signal magnitude information to assist in beam steering.

The beam forming block 444 may include analog circuits, digital circuits, a combination of analog and digital circuits, hardwired or programmable processing, or other means for processing the input signals and altering the individual microphones and the microphone array and/or the processing of the individual microphone 410,415,420 output signals to achieve the desired beam steering. The beam steering has the effect of focusing the sensitivity of the microphone array 515 as a whole toward a desired sound source, such as the human speaker 505. It may alternatively be used to steer the sensitivity away from an objectionable sound source.

Advantageously, the beam steering will be used to increase the human speaker 505 (or other sound source) signal to background noise ratio or to otherwise achieve a desired result. The output 545 of the beam forming block 444 is combined with an output 560 from a background noise cancellation block 565. The background noise canceller 412 receives a background noise input signal 570 as the output electrical signal of an ambient noise microphone 410. This ambient noise microphone 410 is primarily responsible for sensing or detecting an acoustic ambient noise signal and transducing or otherwise converting it into an electrical ambient noise signal 570 which it communicates to a background noise canceller 412. Since the microphone array 515 may advantageously be steered toward the user 505 and may advantageously include a directional characteristic such that most of the sensitivity of the microphone array 515 is in the direction of the user 505, the amount or signal strength of the steerable microphone array 515 relative to the user will be higher for the user signal and lower for the ambient noise.

The amount or signal strength of the ambient noise microphone 410 relative to the user 505 will be lower for the user signal and higher for the ambient noise because of the non-steerable and typically non-directional character of the ambient noise microphone 410. In at least one non-limiting embodiment, the use of a plurality of microphones for sensing the user's 50 or speakers sounds may provide added sensitivity over the sensitivity of a single ambient noise microphone. It should however be appreciated that multiple microphones may be used for the ambient noise sensing.

The output signal 545 from the beam forming block 444 is combined with the output signal 560 from the background noise canceller 412 to generate a signal 585 that is communicated to other processing circuitry, such as for example to the frequency domain noise enhancer in the embodiment if FIG. 4.

The headset will have nonvolatile storage for multimedia data files, typically music files, for example through a Flash RAM. There are many methods by which the multimedia data files may be loaded into the headset memory, for example via a wireless connection to the Internet, via a cellular telephone connection, via a satellite (e.g. XM or Sirius) or AM/FM radio receiver, via a USB high-speed data port, or via a wired or wireless connection to another device (e.g. a wireless connection to a computer, music server, handset, PDA, or other wireless device). The library may be partitioned by media type, for example, there may be one partition of the memory for music, one for phone numbers, and the like.

File storage will include the capability to add “tags” to files. The tagging is done to facilitate searching based on tags that the user selects for each media type. For example, a music file might have a tag or tags such as file title, song title, artist, keywords, genre, album name, music sample or clip, and the like. The headset will contain intelligent software for searching multimedia files stored on the headset based on multiple search criteria and by the type of file of interest. Alternatively, a user can set up certain tags for all files downloaded under the given tagging criterion. The user need only enter this tag or set of tags once, and then change the tag or tags when a change is desired so that, for example, all music downloaded at a given time will have the same tag. This is particularly useful for a headset since it is very hard to do manual entry for each new file.

The search engine (SE) will implement a search algorithm consisting of a multistep process to locate a file or set of files of interest. This generalized search engine will re-use a number of similar functions for different kind of searches such as speech recognition and name recognition. The search engine (SE) interacts with the user through the user interface, which for example can be control buttons or via speech. In the case of speech commands, the headset synthesizes a speech signal to query the user, and the user's speech commands are processed by a speech recognition engine and then sent to the SE. The noise cancellation (and beamforming) 145 capabilities of the microphone array, described above, can be combined with the speech recognition engine to improve its performance.

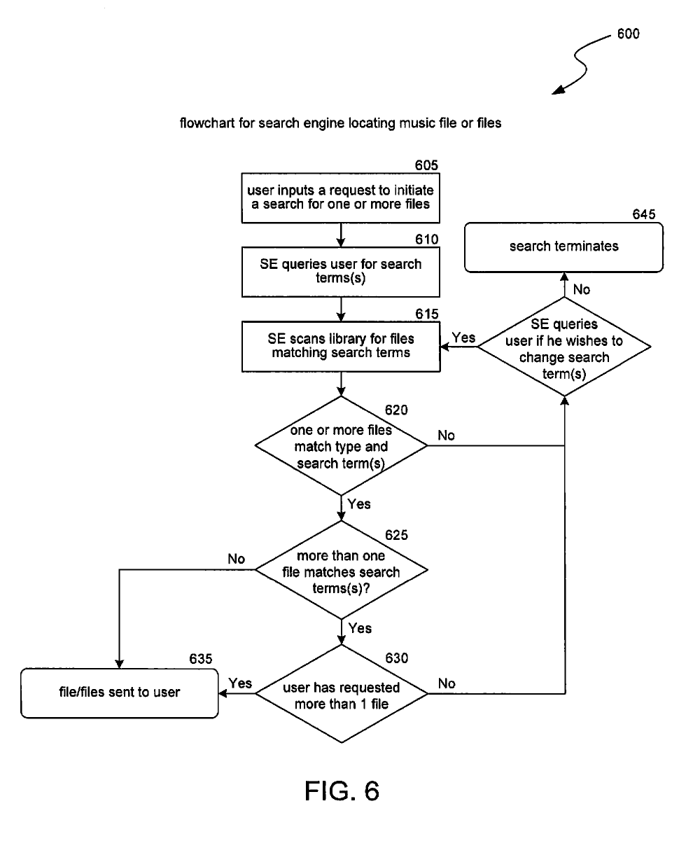

FIG. 6 illustrates a flowchart of the multistep process by which a user locates a desired music file or set of files (or other type of multimedia file) according to some embodiments. More particularly, in the non-limiting embodiment of the process 600 in FIG. 6, a user inputs a request to initiate a search for one or more files (step 605). The search engine (SE) then queries the user for search term(s) or other search criteria or logic (step 610). The search engine sans a library (or other database, source, or storage) for files or content matching the search terms (step 615). If the search engine determines (step 620) that one or more files match type and search term(s) or other specified search criteria (yes), then the process proceeds to make a second determination (step 625) as to whether more than one file or content matches the search term(s) or other search criteria. If the determination is that they do match (yes), the process continues to determine if the user has requested more than one file or content (step 630). If the user has requested more than one file or content (yes), the file or files or other content are sent to the user making the search (step 635).

Retuning to the step of determination (step 625) as to whether more than one file or content matches the search term(s) or other search criteria. If the determination is that only one file or content matches (no), that file or content is sent to the user (step 635). If either the step of determining if one or more files match type and search term(s) (step 620), or the step of determining if the user has requested more than 1 file are negative (step 630), then a determination is made in which the search engine queries the user to determine if the user wishes to change the search term(s) or other search criteria (step 640). If the answer is yes, then the step of the search engine scanning the library or other database, storage, or other potential file or content source (step 615) is repeated. If the determination (step 640) is no, then the search terminates (step 645). The user may of course repeat the search at any time with different search terms. It may be appreciated that this search engine logic is exemplary and non-limiting and that other search engine logic or procedures may be implemented. Furthermore, although the search may be directed to files or content such as music, it may alternatively be directed to other types of content such as audio books, pod casts, or other content.

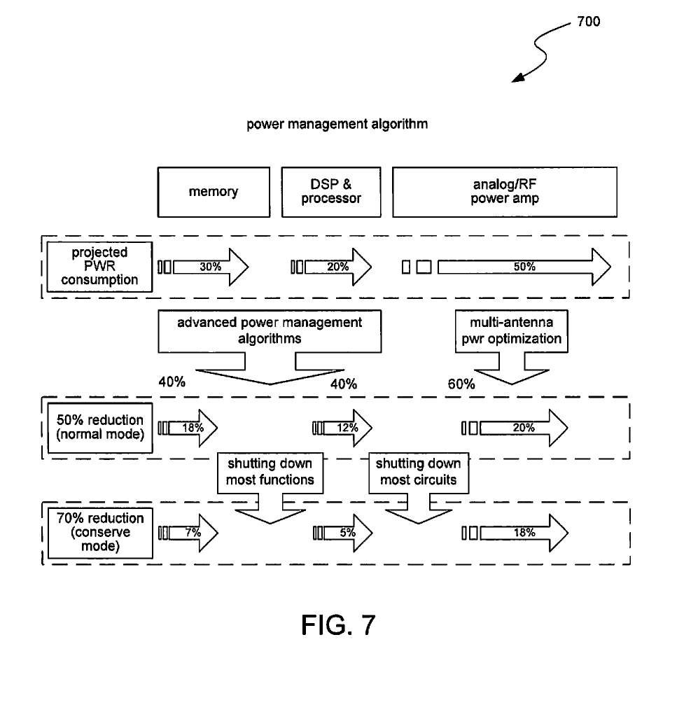

As shown in FIG. 2, the headset may have an optional power management algorithm that minimizes power consumption based on the usage of the handset. FIG. 7 illustrates details of the power management algorithm according to some embodiments. As shown in this figure of FIG. 7, components of the power management algorithm and procedure 700 may advantageously include managing power consumption associated with audio, memory, DSP, and/or processors to be minimized while supporting the applications in use. For example these may be accomplished by utilizing multiple antennas (MIMO) in the most efficient way to minimize the power consumption required for wireless transmission; shutting down certain nonessential device functionality, and turning off nonessential device circuitry.

The headset may be designed such that a certain application or set of applications that require relatively low power can be maintained for an indefinite time period under solar power alone, for example using solar cells embedded in the device and aggressive power management will allow the device to support the given application(s) indefinitely without recharging by shutting down all nonessential functions except those associated with the specific application or applications. For example, the device may operate indefinitely without recharging in Bluetooth-only or Zigbee-only mode by shutting down all functions not associated with maintaining a low-rate wireless connection to the handset through Bluetooth or Zigbee; in voice-only mode the device may operate indefinitely without recharging by shutting down all functionality of the device not associated with making a voice call (e.g. certain memory access, audio processing, noise cancellation, and search algorithms) through one or more interfaces that support such calls (e.g., 2G, 3G, GSM, VoIP over Wifi), and the like. Exemplary strategies and processes are illustrated in the embodiment of FIG. 7, and are provided by way of example but not of limitation.

The headset may advantageously support simultaneous operation on the different wireless interfaces, such as for example simultaneous operation on at least two systems that may include Wifi (802.11a/b/g/n), Wimax, 3G cellular, 2G cellular, GSM-EDGE, radio (e.g. AM/FM/XM), 802.15 (Bluetooth, UWB, and Zigbee) and GPS. These systems often operate at different frequencies and may require different antenna characteristics. The simultaneous operation over different frequencies can be done, for example, by using some set of antennas for one system and using another set of antennas for another system.

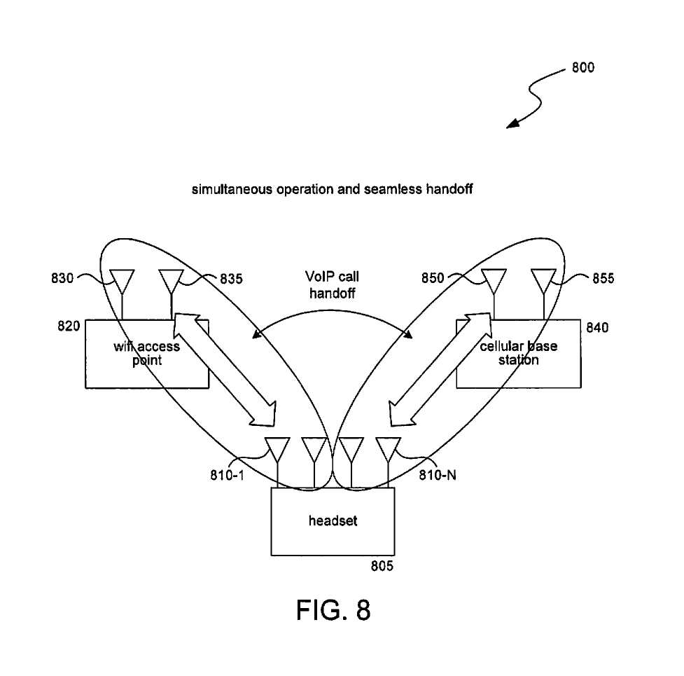

FIG. 8 illustrates simultaneous operation over a cellular system and a Wifi system according to some embodiments. In these embodiments, a headset 805 having a plurality of antennas 810-1, 810-2, 810-3, and 810-4 is able to connect to a wi-fi access point 820 via its one or more antennas 830, 835 and to a cellular base station 840 via one or more base station antennas 850, 855. A voice over IP call handoff between a wi-fi and cellular connection may advantageously be implemented. Another mechanism to support this simultaneous multifrequency operation is time division. In addition to simultaneous operation, the handset can support seamless handoff between two systems. For example, the handset could switch a VoIP call from a wide-area wireless network such as Wimax or 3G to a local area network such as Wifi. FIG. 8 also illustrates the seamless handoff of a VoIP call between a cellular and Wifi system.

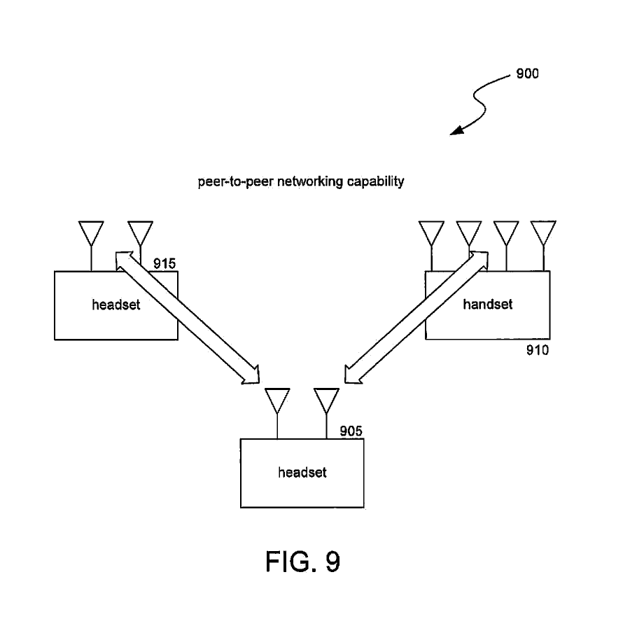

FIG. 9 illustrates a peer-to-peer networking protocol used to establish direct or multihop connections with other wireless devices for real-time interaction and file exchange according to some embodiments. As shown in the exemplary embodiment 900 of FIG. 9, peer-to-peer connectivity may be accomplished between a plurality of headsets, handsets, or other network elements. This protocol can make use of all wireless interfaces that can establish a direct connection with other wireless devices. For example, it could use an 802.11a/b/g/n interface operating in peer-to-peer mode, an 802.15 interface, a proprietary peer-to-peer radio interface, and/or an infrared communication link. The user may select to establish peer-to-peer networks on all available interfaces simultaneously, on a subset of interfaces, or on a single interface based on a prioritized list of possible interfaces. Alternatively, the peer-to-peer network may be established based on a list or set of lists of specific devices or user IDs that the user wishes to interact with.

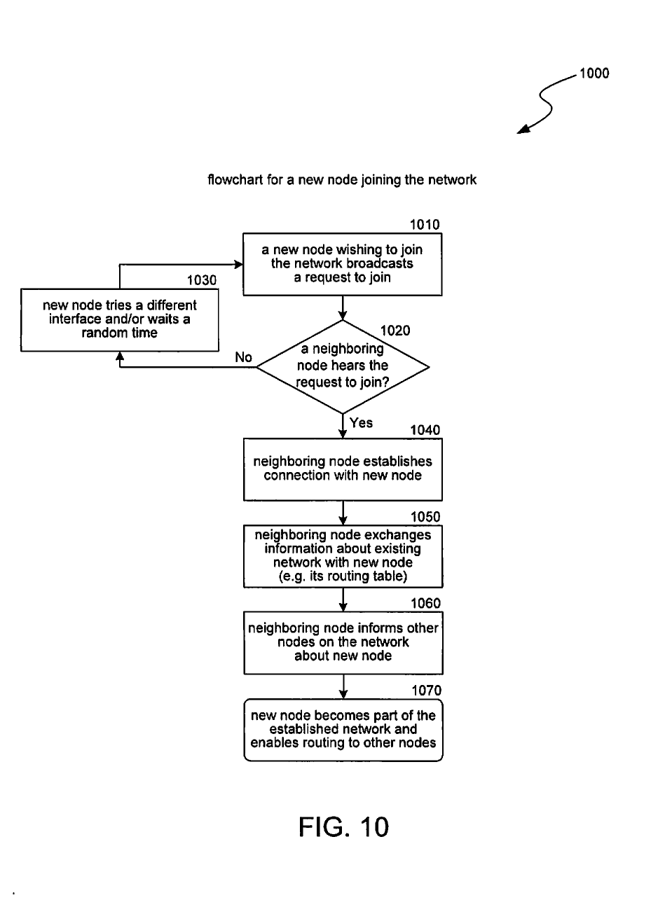

There are two main components to the peer-to-peer networking protocol: neighbor discovery and routing. In neighbor discovery a handset determines which other devices it can establish a direct connection with. This may be done, for example, by setting aside a given control channel for neighbor discovery, where nodes that are already in the peer-to-peer network listen on the control channel for new nodes beginning the process of neighbor discovery. When a node first begins the process of neighbor discovery, it broadcasts a beacon identifying itself over a control channel set up for this purpose. Established nodes on the network periodically listen on the control channel for new nodes. If an established node on the network hears a broadcast beacon, it will establish a connection with the broadcasting node. The existing node will exchange information with the new node about the existing network to which it belongs, e.g. it may exchange the routing table it has for other nodes in the network with the new node. The neighboring node will also inform other nodes on the network about the existence of the new node, and that it can be reached via the neighboring node, e.g. by exchanging updated routing tables with the other nodes. At that point the new node becomes part of the network and activates the routing protocol to communicate with all nodes in the network. FIG. 10 illustrates a flow chart describing this process according to some embodiments.

The routing protocol will take advantage of link layer flexibility in establishing and utilizing single and multihop routes between nodes with the best possible end-to-end performance. The routing protocol will typically be based on least-cost end-to-end routing by assigning costs for each link used in an end-to-end route and computing the total cost based on these link costs. The cost function is designed to optimize end-to-end performance. For example, it may take into account the data rates, throughput, and/or delay associated with a given link in coming up with a cost of using that link. It may also adjust link layer parameters such as constellation size, code rate, transmit power, use of multiple antennas, etc., to reduce the cost of a link and thereby the cost of an end-to-end route.

In addition, for nodes with multiple antennas, multiple independent paths can be established between these nodes, and these independent paths can comprise separate links over which a link cost is computed. The routing protocol can also include multiple priorities associated with routing of each data packet depending on data priority, delay constraints, user priority, and the like.

The headset will also be developed as an open architecture so that third party applications can utilize the handset capabilities of high-fidelity sound, large memory, advanced searching capabilities, peer-to-peer networking, and multiple wireless connections. The architecture of the handset will enable this by providing the appropriate subsystem and software interfaces.

As shown in FIG. 2, the headset has a power management algorithm that minimizes power consumption based on the usage of the headset. FIG. 7 illustrates details of the power management algorithm according to some embodiments. As shown in this figure, components of the power management algorithm include managing power consumption associated with audio, memory, DSP, and/or processors to be minimized while supporting the applications in use; utilizing multiple antennas (MIMO) in the most efficient way to minimize the power consumption required for wireless transmission; shutting down certain nonessential device functionality, and turning off nonessential device circuitry.

The headset will be designed such that a certain application or set of applications that require relatively low power can be maintained for an indefinite time period under solar power alone, i.e. solar cells embedded in the device and aggressive power management will allow the device to support the given application(s) indefinitely without recharging by shutting down all nonessential functions except those associated with the specific application or applications. For example, the device may operate indefinitely without recharging in Bluetooth-only or Zigbee-only mode by shutting down all functions not associated with maintaining a low-rate wireless connection to the handset through Bluetooth or Zigbee; in voice-only mode the device may operate indefinitely without recharging by shutting down all functionality of the device not associated with making a voice call (e.g. certain memory access, audio processing, noise cancellation, and search algorithms) through one or more interfaces that support such calls (e.g. 2G, 3G, GSM, VoIP over Wifi), etc.

The headset supports simultaneous operation on the different wireless interfaces, i.e. simultaneous operation on at least two systems that may include Wifi (802.11a/b/g/n), Wimax, 3G cellular, 2G cellular, GSM-EDGE, radio (e.g. AM/FM/XM), 802.15 (Bluetooth, UWB, and Zigbee) and GPS. These systems often operate at different frequencies. The simultaneous operation over different frequencies can be done, for example, by using some set of antennas for one system and using another set of antennas for another system.

Another mechanism to support this simultaneous multifrequency operation is time division. In addition to simultaneous operation, the handset can support seamless handoff between two systems. For example, the handset could switch a VoIP call from a wide-area wireless network such as Wimax or 3G to a local area network such as Wifi. FIG. 8 also illustrates the seamless handoff of a VoIP call between a cellular and Wifi system.

FIG. 9 illustrates peer-to-peer networking used to establish direct or multihop connections with other wireless devices for real-time interaction and file exchange according to some embodiments. This protocol can make use of all wireless interfaces that can establish a direct connection with other wireless devices. For example, it could use an 802.11a/b/g/n interface operating in peer-to-peer mode, an 802.15 interface, a proprietary peer-to-peer radio interface, and/or an infrared communication link. The user may select to establish peer-to-peer networks on all available interfaces simultaneously, on a subset of interfaces, or on a single interface based on a prioritized list of possible interfaces. Alternatively, the peer-to-peer network may be established based on a list or set of lists of specific devices or user IDs that the user wishes to interact with.

There are two main components to the peer-to-peer networking protocol: neighbor discovery and routing. In neighbor discovery a handset determines which other devices it can establish a direct connection with. This may be done, for example, by setting aside a given control channel for neighbor discovery, where nodes that are already in the peer-to-peer network listen on the control channel for new nodes beginning the process of neighbor discovery. When a node first begins the process of neighbor discovery, it broadcasts a beacon identifying itself over a control channel set up for this purpose. Established nodes on the network periodically listen on the control channel for new nodes. If an established node on the network hears a broadcast beacon, it will establish a connection with the broadcasting node. The existing node will exchange information with the new node about the existing network to which it belongs, e.g. it may exchange the routing table it has for other nodes in the network with the new node. The neighboring node will also inform other nodes on the network about the existence of the new node, and that it can be reached via the neighboring node, e.g. by exchanging updated routing tables with the other nodes. At that point the new node becomes part of the network and activates the routing protocol to communicate with all nodes in the network. A flow chart describing this process is shown in FIG. 10.

The routing protocol will take advantage of link layer flexibility in establishing and utilizing single and multihop routes between nodes with the best possible end-to-end performance. The routing protocol will typically be based on least-cost end-to-end routing by assigning costs for each link used in an end-to-end route and computing the total cost based on these link costs. The cost function is designed to optimize end-to-end performance. For example, it may take into account the data rates, throughput, and/or delay associated with a given link in coming up with a cost of using that link. It may also adjust link layer parameters such as constellation size, code rate, transmit power, use of multiple antennas, etc., to reduce the cost of a link and thereby the cost of an end-to-end route.

In addition, for nodes with multiple antennas, multiple independent paths can be established between these nodes, and these independent paths can comprise separate links over which a link cost is computed. The routing protocol can also include multiple priorities associated with routing of each data packet depending on data priority, delay constraints, user priority, etc.

The headset will also be developed as an open architecture so that third party applications can utilize the handset capabilities of high-fidelity sound, large memory, advanced searching capabilities, peer-to-peer networking, and multiple wireless connections. The architecture of the handset will enable this by providing the appropriate subsystem and software interfaces.

We claim:

1. A method for designing a multimedia headset capable of supporting multiple wireless interfaces, advanced search capability, high fidelity sound, ultra low power operation and peer-to-peer networking.

2. The method of claim 1 where the wireless interfaces may include one or more local-area network interfaces such as Wifi (802.11a/b/g/n); one or more wide-area network interfaces such as Wimax, 3G cellular, 2G cellular, GSM-Edge; radio (e.g. AM/FM/XM); 802.15 (Bluetooth, UWB, and Zigbee); and GPS.

3. The method of claim 1 where Voice-over-IP (VoIP) software utilizes one or more of the wireless interfaces to access the Internet.

4. The method of claim 3 where wireless interfaces for use with VoIP software are prioritized according to the cost of using that interface for Internet access.

5. The method of claim 2 where simultaneous operation over two or more different wireless systems at the same or different frequencies is supported.

6. The method of claim 5 where simultaneous operation over different frequencies is supported by assigning one or more antennas to one frequency and one or more different antennas are assigned to a different frequency.

7. The method of claim 5 where simultaneous operation over different frequencies is supported by a multiband radio combined with multiband antennas.

9. The method of claim 5, where seamless handoff of an application between the two systems is supported.

10. The method of claim 9, where the application is VoIP.

11. The method of claim 1 where the advanced search capability on the headset is based on voice commands.

12. The method of claim 11 where advanced noise cancellation techniques are combined with speech recognition software to improve the performance of voice-driven commands for search.

13. The method of claim 12 where the wireless interfaces are used to access data and/or algorithms on other wireless devices to provide input to the speech recognition algorithm.

14. The method of claim 1 where the advanced search capability on the headset is based on user input from control buttons.

15. The method of claim 1 where the user data can be tagged when it is stored or accessed on the device, and the search capability takes advantage of this tagging in the search process.

16. The method of claim 15, where the user can set up automatic assignment of a tag or set of tags for each data type loaded onto the device.

17. The method of claim 16 where the automatic assignment of tags allows search for tagged data without any manual inputs by the user.

18. The method of claim 1 where the high fidelity sound system uses a microphone array to reduce ambient noise and improve signal quality.

19. The method of claim 18 where beamforming is the array mechanism used for improved performance.

20. The method of claim 19, where beamforming is used to increase the signal quality by pointing in the direction of the speaker.

21. The method of claim 1 where solar cells are used to recharge the batteries of the headset.

22. The method of claim 21 where the headset supports a certain application or class of applications indefinitely based only on recharging from solar cells.

23. The method of claim 1, where advanced power management algorithms are used to increase the battery life of the headset.

24. The method of claim 1, where peer-to-peer networking between headsets and other devices is based on neighbor discovery and routing.

25. The method of claim 24, where the routing is based on a least-cost metric for computing the best route.

26. The method of claim 25, where link layer parameters such as data rate, coding, antenna use, and transmit power are adapted to reduce the cost associated with the use of a given link, and thereby reduce the cost of end-to-end routes utilizing that link.

27. The method of claim 1, where the open architecture allows third party applications to utilize the headset capabilities of high-fidelity sound, memory, advanced searching capabilities, peer-to-peer networking, and multiple wireless connections by providing the appropriate subsystem and software interfaces.

28. A multimedia headset comprising:
a plurality of multiple wireless interfaces;
an advanced search engine with media search capability;
a high fidelity sound processor;
power management means for ultra low power operation;
network connectivity for peer-to-peer networking.

29. The headset of claim 28 wherein the interfaces are wireless interfaces and include one or more local-area network interfaces: Wifi (802.11a/b/g/n); one or more wide-area network interfaces such as Wimax, 3G cellular, 2G cellular, GSM-Edge; radio (e.g. AM/FM/XM); 802.15 (Bluetooth, UWB, and Zigbee); and GPS.

30. The headset of claim 28, further including a Voice-over-IP (VoIP) software that utilizes one or more of the wireless interfaces to access the Internet.

31. The headset of claim 30, further comprising a wireless interface for use with VoIP software are prioritized according to the cost of using that interface for Internet access.

32. The headset of claim 29, further including means supporting simultaneous operation over two or more different wireless systems at the same or different frequencies is supported.

33. The headset of claim 32, wherein simultaneous operation over different frequencies is supported by assigning one or more antennas to one frequency and one or more different antennas are assigned to a different frequency.

34. The headset of claim 32, wherein the simultaneous operation over different frequencies is supported by a multiband radio combined with multiband antennas.

35. The headset of claim 32, wherein the simultaneous operation over different frequencies is supported by time-division.

36. The headset of claim 32, further including means for seamless handoff of an application between the two systems is supported.

37. The headset of claim 36, wherein the application is VoIP.

38. The headset of claim 28, further including a search engine having an advanced search capability on the headset is based on voice commands.

39. The headset of claim 28, further comprising an advanced noise cancellation processor and are a speech recognition software in combination to improve the performance of voice-driven commands for search.

40. The headset of claim 39, wherein wireless interfaces are used to access data and/or algorithms on other wireless devices to provide input to the speech recognition algorithm.

41. The headset of claim 28, where the advanced search capability on the headset is based on user input from control buttons.

42. The headset of claim 1, wherein the user data is tagged when it is stored or accessed on the device, and the search capability takes advantage of this tagging in the search process.

43. The headset of claim 42, wherein the user can set up automatic assignment of a tag or set of tags for each data type loaded onto the device.

44. The headset of claim 43, wherein the automatic assignment of tags allows search for tagged data without any manual inputs by the user.

45. The headset of claim 28, wherein the high fidelity sound system uses a microphone array to reduce ambient noise and improve signal quality.

46. The headset of claim 45, wherein beamforming is the array mechanism used for improved performance.

47. The headset of claim 46, wherein beamforming is used to increase the signal quality by pointing in the direction of the speaker.

48. The headset of claim 28, wherein solar cells are used to recharge the batteries of the headset.

49. The headset of claim 28, wherein the headset supports a certain application or class of applications indefinitely based only on recharging from solar cells.

50. The headset of claim 28, wherein advanced power management algorithms are used to increase the battery life of the headset.

51. The headset of claim 28, wherein peer-to-peer networking between headsets and other devices is based on neighbor discovery and routing.

52. The headset of claim 28, where the routing is based on a least-cost metric for computing the best route.

53. The headset of claim 28 where link layer parameters such as data rate, coding, antenna use, and transmit power are adapted to reduce the cost associated with the use of a given link, and thereby reduce the cost of end-to-end routes utilizing that link.

54. The headset of claim 28, wherein the open architecture allows third party applications to utilize the headset capabilities of high-fidelity sound, memory, advanced searching capabilities, peer-to-peer networking, and multiple wireless connections by providing the appropriate subsystem and software interfaces.
